(19) United States
(12) Patent Application Publication
(10) Pub. No.: US 2016/0175714 A1
(43) Pub. Date: Jun. 23, 2016

(54) COMPUTER-READABLE RECORDING MEDIUM, COMPUTER APPARATUS, AND COMPUTER PROCESSING METHOD

(71) Applicant: SQUARE ENIX CO., LTD., Tokyo (JP)

(72) Inventor: Ryotaro ISHII, Tokyo (JP)

(73) Assignee: SQUARE ENIX CO., LTD., Tokyo (JP)

(21) Appl. No.: 14/964,855

(22) Filed: Dec. 10, 2015

(30) Foreign Application Priority Data
Dec. 19, 2014 (JP) 2014-256893

(51) Int. Cl. A63F 13/55; G06F 3/0481; G06F 3/0488

(52) U.S. Cl. CPC A63F 13/55; G06F 3/04886; G06F 3/04817

(57) ABSTRACT

Disclosed are a program, a computer apparatus, a computer processing method, and a system capable of inputting one guidance among one or more guidances which can be given to a character without deteriorating visibility. A program executed in a computer apparatus that includes a display device having a touch-panel display screen causes the computer apparatus to function as: a character selector that selects a character according to a user's initial contact location with respect to the display screen from among a plurality of characters which are displayed on the display screen and can be selected by a user; a guidance information displayer that displays, when the character is selected by the character selector, guidance information indicating one or more guidances which can be given to the character on the display screen; and an inputter that receives an input of the user with respect to the guidance information displayed by the guidance information displayer.

### CROSS REFERENCE TO RELATED APPLICATION

The present disclosure relates to subject matter contained in Japanese Patent Application No. 2014-256893, filed on Dec. 19, 2014, the disclosure of which is expressly incorporated herein by reference in its entirety.

### TECHNICAL FIELD

The present invention relates to a computer-readable recording medium, a computer apparatus, and a computer processing method.

### BACKGROUND ART

In the related art, game software for a home video game console has been provided, but recently, game applications for a smart phone have been provided. In the home video game console, a game is progressed by operation of cross directional keypads or plural buttons, but in the smart phone, the game is progressed by operation of a touch panel, and thus, it is necessary to design a game screen or an operation method in consideration of an operation with respect to the touch panel. For example, in a game which progresses by selection of a guidance from a user, such as a role playing game (RPG), buttons corresponding to selectable plural guidances are displayed on a game screen in advance, and then, guidance selection is performed.

### SUMMARY OF THE INVENTION

### Technical Problem

However, in a game which is progressed by selection of a guidance to be executed by a character from among plural options, such as an RPG, in order to display all the options on a screen, a method of reducing the display of the options may be considered, for example, but in this case, visibility or operability may be lowered. Further, when the game is progressed by a user, if the options are constantly displayed on the screen regardless of the timing when the guidance to be followed by the character is input, for example, a display area of a character image or information about the character becomes small, visibility may be insufficient.

An object of at least one embodiment of the invention is to provide a program, a computer apparatus, a computer processing method, and a system capable of inputting one guidance among one or more guidances which can be given to a character without deteriorating visibility.

### Solution to Problem

According to a non-limiting aspect, a computer-readable recording medium of the present invention is the non-transitory computer-readable recording medium having recorded thereon an program which is executed in a computer apparatus that includes a display device having a touch-panel display screen, the program causing the computer apparatus to function as: a character selector that selects a character according to a user's initial contact location with respect to the display screen from among a plurality of characters which are displayed on the display screen and can be selected by a user; a guidance information displayer that displays, when the character is selected by the character selector, guidance information indicating one or more guidances which can be given to the character on the display screen; and an inputter that receives an input of the user with respect to the guidance information displayed by the guidance information displayer.

According to a non-limiting aspect, a computer apparatus of the present invention is the computer apparatus that includes a display device having a touch-panel display screen, including: a character selector that selects a character according to a user's initial contact location with respect to the display screen from among a plurality of characters which are displayed on the display screen and can be selected by a user; a guidance information displayer that displays, when the character is selected by the character selector, guidance information indicating one or more guidances which can be given to the character on the display screen; and an inputter that receives an input of the user with respect to the guidance information displayed by the guidance information displayer.

According to a non-limiting aspect, a computer processing method of the present invention is the computer processing method executed in a computer apparatus that includes a display device having a touch-panel display screen, the method executing the steps of: selecting a character according to a user's initial contact location with respect to the display screen from among a plurality of characters which are displayed on the display screen and can be selected by a user; displaying, when the character is selected, guidance information indicating one or more guidances which can be given to the character on the display screen; and receiving an input of the user with respect to the displayed guidance information.

### Advantageous Effects of Invention

One or more of the above problems can be solved with each embodiment of the present invention.

### BRIEF DESCRIPTION OF THE DRAWINGS

FIG. 1 is a block diagram illustrating a configuration of a computer apparatus, corresponding to at least one of embodiments of the invention.

FIG. 2 is a flowchart of a program execution process, corresponding to at least one of the embodiments of the invention.

FIG. 3 is a block diagram illustrating a configuration of a server apparatus, corresponding to at least one of the embodiments of the invention.

FIG. 4 is a flowchart of a program execution process, corresponding to at least one of the embodiments of the invention.

FIG. 5 is a block diagram illustrating a configuration of a computer apparatus, corresponding to at least one of the embodiments of the invention.

FIG. 6 is a flowchart of a program execution process, corresponding to at least one of the embodiments of the invention.

FIG. 7 is a block diagram illustrating a configuration of a computer apparatus, corresponding to at least one of the embodiments of the invention.

FIG. 8 is a block diagram illustrating a configuration of a terminal apparatus, corresponding to at least one of the embodiments of the invention.

FIG. 9 is a flowchart of a program execution process, corresponding to at least one of the embodiments of the invention.

FIG. 10 is a block diagram illustrating a configuration of a computer apparatus, corresponding to at least one of the embodiments of the invention.

FIG. 11 is an example of a program execution screen, corresponding to at least one of the embodiments of the invention.

FIG. 12 is a flowchart of a program execution process, corresponding to at least one of the embodiments of the invention.

FIG. 13 is a diagram illustrating a guidance information master, corresponding to at least one of the embodiments of the invention.

FIG. 14 is a flowchart of the action performance process, corresponding to at least one of the embodiments of the invention.

FIG. 15 is a diagram illustrating a character action table, corresponding to at least one of the embodiments of the invention.

FIGS. 16A and 16B are conceptual diagrams relating to a user's contact with a display screen, corresponding to at least one of the embodiments of the invention.

FIGS. 17A to 17D are examples of a performance process in character selection, corresponding to at least one of the embodiments of the invention.

FIG. 18 is a flowchart of a guidance information selection reception process, corresponding to at least one of the embodiments of the invention.

FIG. 19 is a conceptual diagram relating to a change in a process based on a changed contact location, corresponding to at least one of the embodiments of the invention.

FIG. 20 is a block diagram illustrating a configuration of a system, corresponding to at least one of the embodiments of the invention.

FIG. 21 is a block diagram illustrating a configuration of a server apparatus, corresponding to at least one of the embodiments of the invention.

FIG. 22 is a flowchart of a program execution process, corresponding to at least one of the embodiments of the invention.

FIG. 23 is a flowchart of an action performance process, corresponding to at least one of the embodiments of the invention.

### DESCRIPTION OF EMBODIMENTS

Hereinafter, embodiments of the invention will be described with reference to the accompanying drawings. Hereinafter, description relating to effects shows an aspect of the effects of the embodiments of the invention, and does not limit the effects. Further, the order of respective processes that form a flowchart described below may be changed in a range without contradicting or creating discord with the processing contents thereof.

### First Embodiment

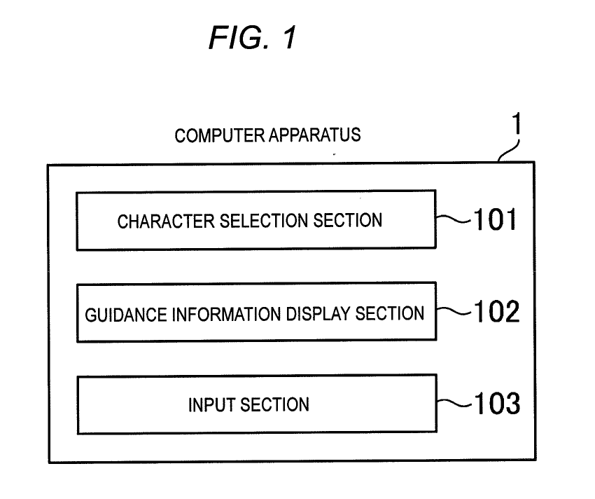

Next, an outline of a first embodiment of the invention will be described. FIG. 1 is a block diagram illustrating a configuration of a computer apparatus, corresponding to at least one of embodiments of the invention. The computer apparatus 1 at least includes a character select section 101, a guidance information display section 102, and an input section 103.

The character select section 101 has a function of selecting a character according to a user's initial contact location with respect to a display screen, from among plural characters which are displayed on the display screen and can be selected by the user. The guidance information display section 102 has a function of displaying, when the character is selected by the character select section 101, guidance information indicating one or more guidances which can be given to the character on the display screen. The input section 103 has a function of receiving an input of the user with respect to the guidance information displayed by the guidance information display section 102.

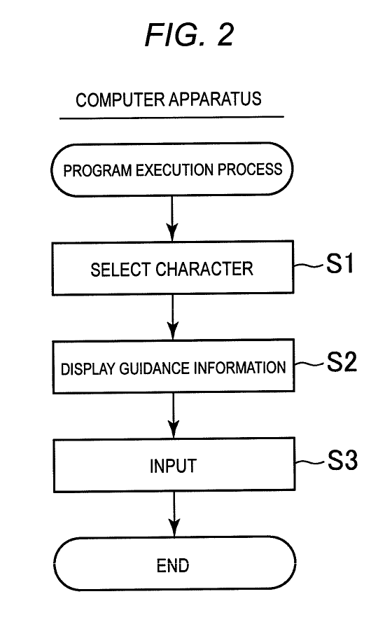

A program execution process in the first embodiment of the invention will be described. FIG. 2 illustrates a flowchart of the program execution process, corresponding to at least one of the embodiments of the invention.

The computer apparatus 1 selects a character according to a user's initial contact location with respect to a display screen, from among plural characters which are displayed on a touch-panel display screen and can be selected by the user (step S1). Then, when the character is selected in step S1, guidance information indicating one or more guidances which can be given to the character is displayed on the display screen (step S2). Finally, an input of the user with respect to the guidance information displayed in step S2 is received (step S3), and then, the procedure is terminated.

As an aspect of the first embodiment, it is possible to input one guidance among one or more guidances which can be given to the character, without deteriorating visibility.

In the first embodiment, the “touch panel” refers to a panel provided with a touch sensor, for example, in which as a person's finger, a stylus or the like (hereinafter, referred to as a finger or the like) comes into contact with a screen, an input operation is performed with respect to a computer apparatus. The “computer apparatus” refers to an apparatus such as a portable phone, a smart phone or a portable video game console, for example. The “user's initial contact location with respect to the display screen” refers to a location which is initially detected by the touch panel in a series of motions, relating to contact with the display screen, of contacting the touch-panel display screen by the user's finger or the like and separating the user's finger or the like from the display screen, for example. The “character” refers to a player character that is present as an alternative to a game player, or a sub character that accompanies the player character, for example, and includes an object that cooperates with the player character. The “guidance information” refers to information relating to a guidance with respect to a character, for example. The “input of the user” refers to an operation for deciding selection of one piece of guidance information from among one or more pieces of guidance information displayed on a screen, for example.

### Second Embodiment

Next, an outline of a second embodiment of the invention will be described. A configuration of a computer apparatus in the second embodiment may employ the same configuration as that shown in the block diagram of FIG. 1. Further, the flow of a program execution process in the second embodiment may employ the same configuration as that shown in the flowchart of FIG. 2.

In the second embodiment, when selecting a character, guidance information is displayed in the vicinity of the selected character or in the vicinity of a user's initial contact location with respect to a display screen.

As an aspect of the second embodiment, since the guidance information is displayed in the vicinity of the selected character or the initial contact location, it is possible to intuitively recognize guidance information capable of being guided with respect to the selected character.

In the second embodiment, the “character” refers to a player character that is present as an alternative to a game player, or a sub character that accompanies the player character, for example, and includes an object that cooperates with the player character. The “user's initial contact location with respect to the display screen” refers to a location which is initially detected by the touch panel in a series of motions, relating to contact with the display screen, of contacting the touch-panel display screen by the user's finger or the like and separating the user's finger or the like from the display screen, for example. The “vicinity of the selected character” refers to a region which is spaced at a predetermined distance on the screen from a region where information relating to the selected character, according to the user's initial contact location with respect to the display screen, is displayed, for example. The “vicinity of the initial contact location” refers to a region which is spaced at a predetermined distance on the screen from the location which is initially detected by the touch panel in the series of motions, relating to contact with the display screen, of contacting the touch-panel display screen by the user's finger or the like and separating the user's finger or the like from the display screen, for example. The “guidance information” refers to information relating to a guidance with respect to the character, for example.

### Third Embodiment

Next, an outline of a third embodiment of the invention will be described. A configuration of a computer apparatus in the third embodiment may employ the same configuration as that shown in the block diagram of FIG. 1. Further, the flow of a program execution process in the third embodiment may employ the same configuration as that shown in the flowchart of FIG. 2.

In the third embodiment, reception of an input from a user refers to reception of information relating to a final contact location where the user ceases the contact to the display screen. Further, a guidance information displayer displays guidance information for a selected character corresponding to information relating to the final contact location capable of being received by an input device on a display screen during a contact operation.

As an aspect of the third embodiment, it is possible to recognize guidance information capable of being selected as a guidance with respect to a character by a user before an input is received.

In the third embodiment, the “contact is finished” refers to a state where after a user brings a finger or the like into contact with a display screen and then separates the finger or the like from the display screen, a touch panel does not detect the contact for a predetermined period of time, for example. The “final contact location” refers to a final location which is detected by the touch panel in a series of motions, relating to contact with the display screen, of contacting the touch-panel display screen by the user's finger or the like and separating the user's finger or the like from the display screen, for example. The “character” refers to a player character that is present as an alternative to a game player or a sub character that accompanies the player character, for example, and includes an object that cooperates with the player character. The “guidance information” refers to information relating to a guidance with respect to a character, for example. The “during the contact operation” refers to a state where the contact with the touch panel is detected in a series of motions, relating to contact with the display screen, of contacting the touch-panel display screen by the user's finger or the like and separating the user's finger or the like from the display screen, for example.

### Fourth Embodiment

Next, an outline of a fourth embodiment of the invention will be described. A configuration of a computer apparatus in the fourth embodiment may employ the same configuration as that shown in the block diagram of FIG. 1. Further, the flow of a program execution process in the third embodiment may employ the same configuration as that shown in the flowchart of FIG. 2.

In the fourth embodiment, before a character is selected, information which is obtained by simplifying guidance information is displayed on a display screen.

As an aspect of the fourth embodiment, since information relating to the guidance information or at least part of the guidance information can be confirmed, a user can efficiently select a character, and can input a guidance.

In the fourth embodiment, the “character” refers to a player character that is present as an alternative to a game player or a sub character that accompanies the player character, for example, and includes an object that cooperates with the player character. The “guidance information” refers to information relating to a guidance with respect to a character, for example. “Simplified information” refers to information represented in a way such that the information relating to the guidance information, or at least part of the guidance information, can be understood.

### Fifth Embodiment

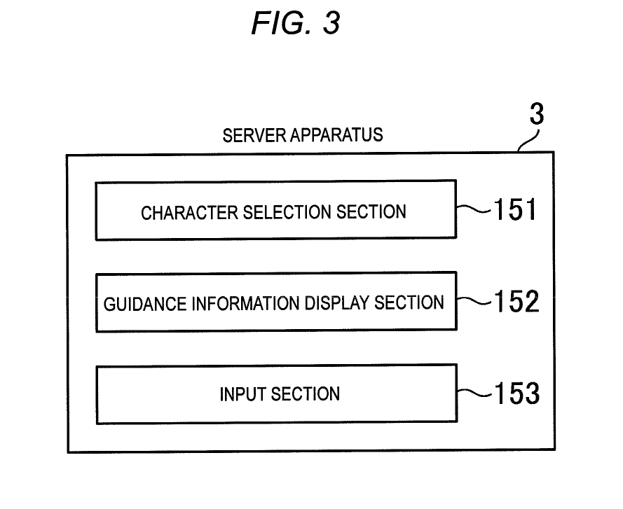

Next, an outline of a fifth embodiment of the invention will be described. FIG. 3 is a block diagram illustrating a configuration of a server apparatus, corresponding to at least one of the embodiments of the invention. A server apparatus 3 at least includes a character select section 151, a guidance information display section 152, and an input section 153.

The character select section 151 has a function of selecting a character according to a user's initial contact location with respect to a display screen from among plural characters which are displayed on the display screen of a terminal apparatus and can be selected by the user. The guidance information display section 152 has a function of displaying, when the character is selected by the character select section 151, at least one or more guidances which can be given to the character on the display screen of the terminal apparatus. The input section 153 has a function of receiving an input of the user with respect to the guidance information displayed by the guidance information display section 152.

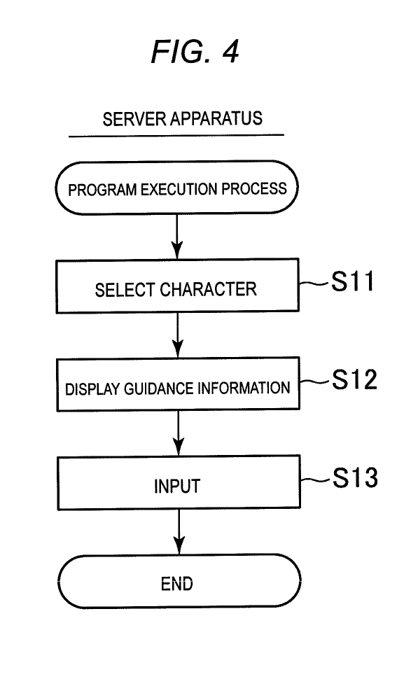

A program execution process in the fifth embodiment of the invention will be described. FIG. 4 illustrates a flowchart of the program execution process, corresponding to at least one of the embodiments of the invention.

The server apparatus 3 selects a character according to a user's initial contact location with respect to a display screen, from among plural characters which are displayed on a touch-panel display screen of the terminal apparatus and can be selected by the user (step S11). Then, when the character is selected in step S11, guidance information indicating one or more guidances which can be given to the character is displayed on the display screen of the terminal apparatus (step S12). Finally, an input of the user with respect to the guidance information displayed in step S12 is received (step S13), and then, the procedure is terminated.

As an aspect of the fifth embodiment, it is possible to input one guidance among one or more guidances which can be given to the character, without deteriorating visibility.

In the fifth embodiment, the “touch panel” refers to a panel provided with a touch sensor, for example, in which as a person's finger comes into contact with a screen, an input operation is performed with respect to a computer. The “terminal apparatus” refers to a computer apparatus such as a portable phone, a smart phone or a portable video game console, for example. The “server apparatus” refers to an apparatus that executes a process according to a request from the terminal apparatus, for example. The “character” refers to a player character that is present as an alternative to a game player or a sub character that accompanies the player character, for example, and includes an object that cooperates with the player character. The “user's initial contact location with respect to the display screen” refers to a location which is initially detected by the touch panel in a series of motions, relating to contact with the display screen of the terminal apparatus, of contacting the touch-panel display screen by the user's finger or the like and separating the user's finger or the like from the display screen, for example. The “guidance information” refers to information relating to a guidance with respect to a character, for example. The “input of the user” refers to an operation for deciding the selection of one piece of guidance information from among one or more pieces of guidance information displayed on a screen, for example.

### Sixth Embodiment

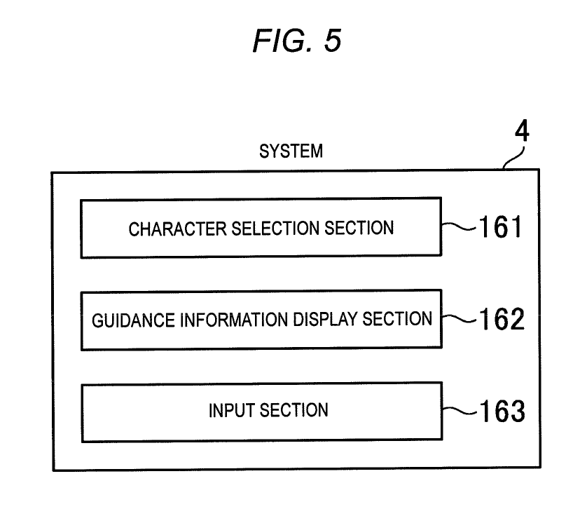

Next, an outline of a sixth embodiment of the invention will be described. FIG. 5 is a block diagram illustrating a configuration of a computer apparatus, corresponding to at least one of the embodiments of the invention. A system 4 at least includes a character select section 161, a guidance information display section 162, and an input section 163.

The character select section 161 has a function of selecting a character according to a user's initial contact location with respect to a display screen, from among plural characters which are displayed on the display screen of a terminal apparatus and can be selected by the user. The guidance information display section 162 has a function of displaying, when the character is selected by the character select section 161, guidance information indicating one or more guidances which can be given to the character on the display screen of the terminal apparatus. The input section 163 has a function of receiving an input of the user with respect to the guidance information displayed by the guidance information display section 162.

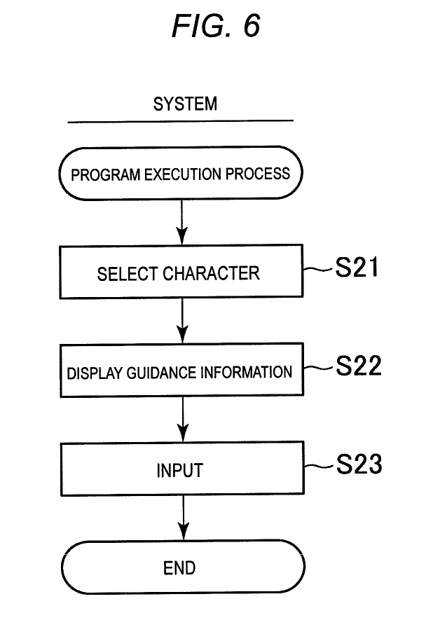

A program execution process in the sixth embodiment of the invention will be described. FIG. 6 illustrates a flowchart of the program execution process, corresponding to at least one of the embodiments of the invention.

The system 4 selects a character according to a user's initial contact location with respect to a display screen, from among plural characters which are displayed on a touch-panel display screen and can be selected by the user (step S21). Then, when the character is selected in step S21, guidance information indicating one or more guidances which can be given to the character is displayed on the display screen (step S22). Finally, an input of the user with respect to the guidance information displayed in step S22 is received (step S23), and then, the procedure is terminated.

As an aspect of the sixth embodiment, it is possible to input one guidance among one or more guidances which can be given to the character, without deteriorating visibility.

In the sixth embodiment, the “touch panel” refers to a panel provided with a touch sensor, for example, in which as a person's finger comes into contact with a screen, an input operation is performed with respect to a computer apparatus. The “terminal apparatus” refers to a computer apparatus such as a portable phone, a smart phone or a portable video game console, for example. The “server apparatus” refers to an apparatus that executes a process according to a request from the terminal apparatus, for example. The “system” refers to a combination of hardware, software, a network, and the like, for example. The “character” refers to a player character that is present as an alternative to a game player or a sub character that accompanies the player character, for example, and includes an object that cooperates with the player character. The “user's initial contact location with respect to the display screen” refers to a location which is initially detected by the touch panel in a series of motions, relating to contact with the display screen of the terminal apparatus, of contacting the touch-panel display screen by the user's finger or the like and separating the user's finger or the like from the display screen, for example. The “guidance information” refers to information relating to a guidance with respect to a character, for example. The “input of the user” refers to an operation for deciding selection of one piece of guidance information from among one or more pieces of guidance information displayed on a screen, for example.

### Seventh Embodiment

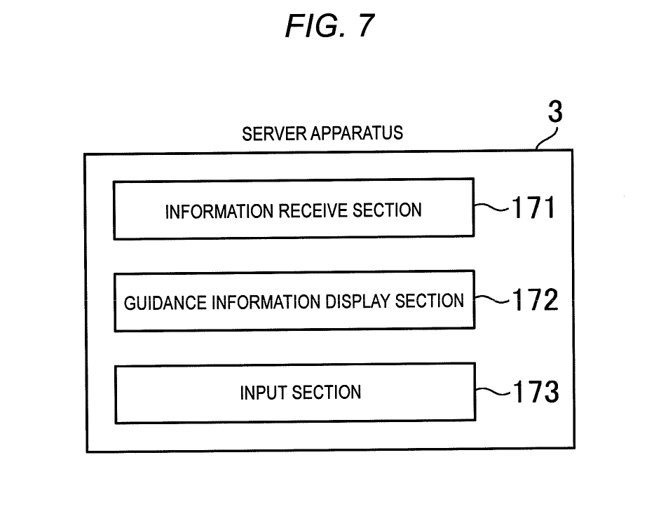

Next, an outline of a seventh embodiment of the invention will be described. FIG. 7 is a block diagram illustrating a configuration of a computer apparatus, corresponding to at least one of the embodiments of the invention. A server apparatus 3 at least includes an information receiver 171, a character select section 172, and a guidance information display section 173.

The information receiver 171 has a function of receiving information transmitted from a terminal apparatus 5. The character select section 172 has a function of selecting a character according to a user's initial contact location with respect to a display screen, from among the information received by the information receiver 171. The guidance information display section 173 has a function of displaying, when the character is selected by the character select section 172, guidance information indicating one or more guidances which can be given to the character on the display screen of the terminal apparatus.

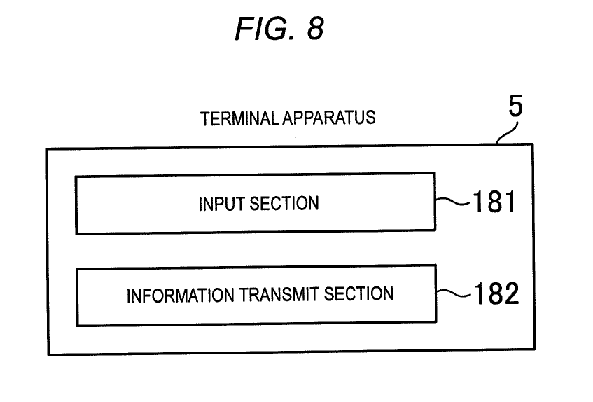

FIG. 8 is a block diagram illustrating a configuration of a terminal apparatus, corresponding to at least one of the embodiments of the invention. The terminal apparatus 5 at least includes an input section 181 and an information transmitter 182.

The input section 181 has a function of receiving information relating to a user's initial contact location with respect to a display screen as an input of the user. The information transmitter 182 has a function of transmitting the information received by the input section 181 to a server apparatus 3.

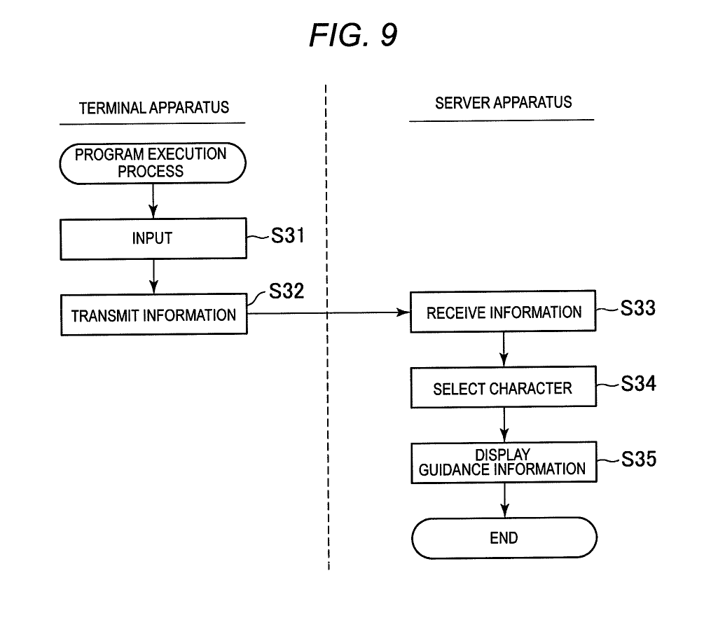

A program execution process in the seventh embodiment of the invention will be described. FIG. 9 illustrates a flowchart of the program execution process, corresponding to at least one of the embodiments of the invention.

The terminal apparatus 5 receives information relating to a user's initial contact location with respect to a display screen, from among plural characters which are displayed on a touch-panel display screen and can be selected by the user, as an input of the user (step S31). Then, the terminal apparatus 5 transmits the received information to the server apparatus 3 (step S32).

The server apparatus 3 receives the information transmitted in step S32 (step S33). Then, the server apparatus 3 selects a character according to the user's initial contact location with respect to the display screen, from the received information (step S34). The server apparatus 3 displays, when the character is selected, guidance information indicating one or more guidances which can be given to the character on the display screen of the terminal apparatus (step S35), and then, the procedure is terminated.

As an aspect of the seventh embodiment, since all the calculation processes are processed in the server apparatus and the terminal apparatus only has to include an input device and a displayer, even in a terminal apparatus that exhibits low performance, it is possible to use a program for which complicated calculation is necessary. Further, as another aspect of the seventh embodiment, it is possible to input one guidance among one or more guidances which can be given to the character, without deteriorating visibility.

In the seventh embodiment, the “server apparatus” refers to an apparatus that executes a process according to a request from the terminal apparatus, for example. The “touch panel” refers to a panel provided with a touch sensor, for example, in which as a person's finger or the like comes into contact with a screen, an input operation is performed with respect to a computer apparatus. The “terminal apparatus” refers to a computer apparatus such as a portable phone, a smart phone or a portable video game console, for example. The “character” refers to a player character that is present as an alternative to a game player or a sub character that accompanies the player character, for example, and includes an object that cooperates with the player character. The “user's initial contact location with respect to the display screen” refers to a location which is initially detected by the touch panel in a series of motions, relating to contact with the display screen, of contacting the touch-panel display screen by the user's finger or the like and separating the user's finger or the like from the display screen, for example. The “guidance information” refers to information relating to a guidance with respect to a character, for example. The “input of the user” refers to an operation for deciding selection of one piece of guidance information from among one or more pieces of guidance information displayed on a screen, for example.

### Eighth Embodiment

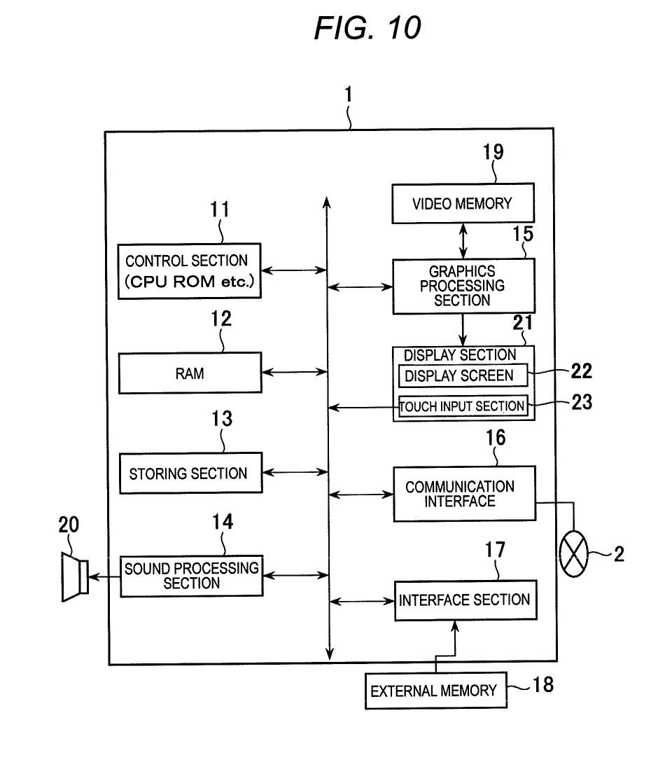

Next, an outline of an eighth embodiment of the invention will be described. FIG. 10 is a block diagram illustrating a configuration of a computer apparatus, corresponding to at least one of the embodiments of the invention. The computer apparatus 1 includes a control section 11, a random access memory (RAM) 12, a storing section 13, a sound processing section 14, a graphics processing section 15, a communication interface 16, and an interface section 17, which are connected to each other through an internal bus.

The control section 11 includes a central processing unit (CPU) and a read only memory (ROM). The control section 11 executes a program stored in the storing section 13, and controls the computer apparatus 1. The RAM 12 is a work area of the control section 11. The storing section 13 is a storage area for storing a program or data.

The control section 11 performs a process of reading a program or data from the RAM 12. The control section 11 processes the program or data loaded to the RAM 12 to output a sound output guidance to the sound processing section 14, and to output a drawing guidance to the graphics processing section 15.

The sound processing section 14 is connected to a sound output device 20 which is a speaker. If the control section 11 outputs the sound output guidance to the sound processing section 14, the sound processing section 14 outputs a sound signal to the sound output device 20.

The graphics processing section 15 is connected to a display section 21. The display section 21 includes a display screen 22. If the control section 11 outputs the drawing guidance to the graphics processing section 15, the graphics processing section 15 develops an image to a video memory 19, and outputs a video signal for displaying the image on the display screen 22. Here, the display section 21 may be a screen of a touch panel provided with a touch sensor.

The graphics processing section 15 executes drawing of one image in the unit of frames. One frame of the image is 1/30 seconds, for example. The graphics processing section 15 has a function of receiving a part of a calculation process relating to drawing, performed only by the control section 11, and distributing the load of the entire system.

An external memory 18 (for example, an SD card or the like) is connected to the interface section 17. Data read from the external memory 18 is loaded to the RAM 12, and then, a calculation process is performed by the control section 11.

The communication interface 16 may be connected to a communication line 2 in a wireless or wired manner, and may receive data through the communication line 2. The data received through the communication interface 16 is loaded to the RAM 12, similar to the data read from the external memory 18, and then, a calculation process is performed by the control section 11.

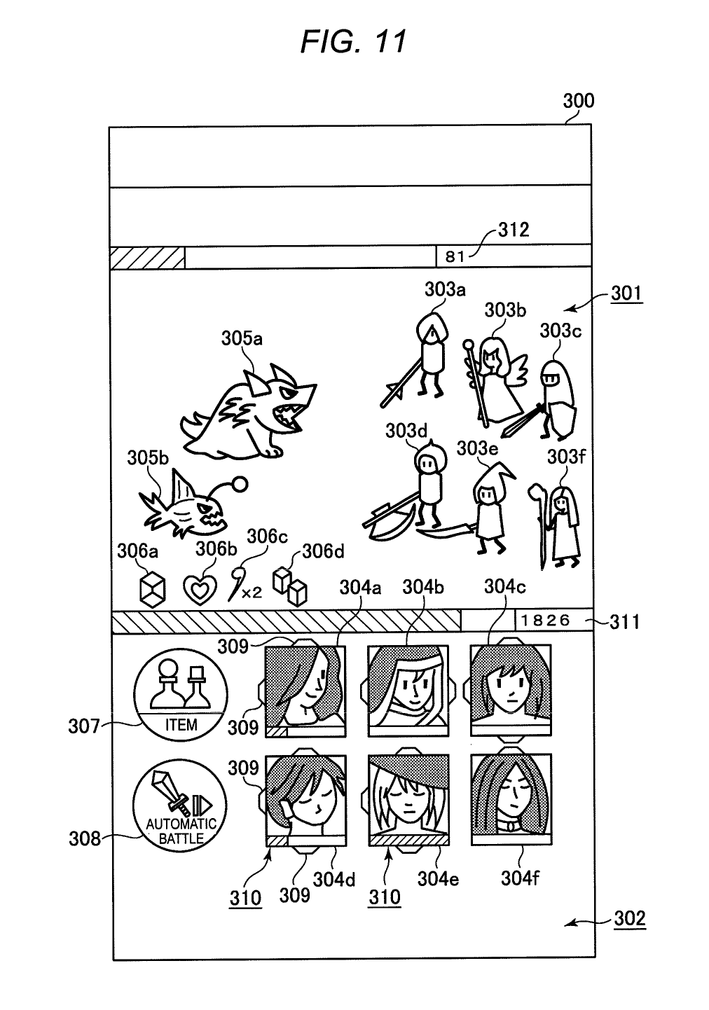

A program execution process in the eighth embodiment of the invention will be described. In the eighth embodiment of the invention, a program of a game where a player character performs a virtual battle with an enemy character is used as an example. FIG. 11 is an example of a program execution screen, corresponding to at least one of the embodiments of the invention.

A battle situation area 301, an action guidance area 302, supporter vitality 311, and an enemy vitality 312 are displayed on an execution screen 300 displayed on the display screen 22 of the computer apparatus 1. The supporter vitality 311 represents a total value of physical forces of plural player characters. If the supporter vitality 311 becomes “0”, a battle impossible state is established, and the game is terminated. The enemy vitality 312 represents a physical force of an enemy character. If the enemy vitality 312 becomes “0”, the enemy character enters a battle impossible state. If all the enemy characters are in the battle impossible state, the virtual battle is terminated.

Player characters 303, enemy characters 305, and effect objects 306 are displayed in the battle situation area 301. An animation based on actions of the player characters 303 and the enemy characters 305 is displayed in the battle situation area 301.

Character guidance buttons 304, an item button 307, an automatic battle button 308, action display images 309, and critical attack point gauges 310 are displayed in the action guidance area 302. The character guidance buttons 304 correspond to the player characters 303, and are used when a guidance is given to each character. The guidance relating to each character will be described later.

The item button 307 is selected to use an item during the virtual battle. The automatic battle button 308 is selected to automatically perform the battle. By pressing the automatic battle button 308, an arbitrary guidance is generated under the control of a program to progress the battle, without any guidance of a user to the player character.

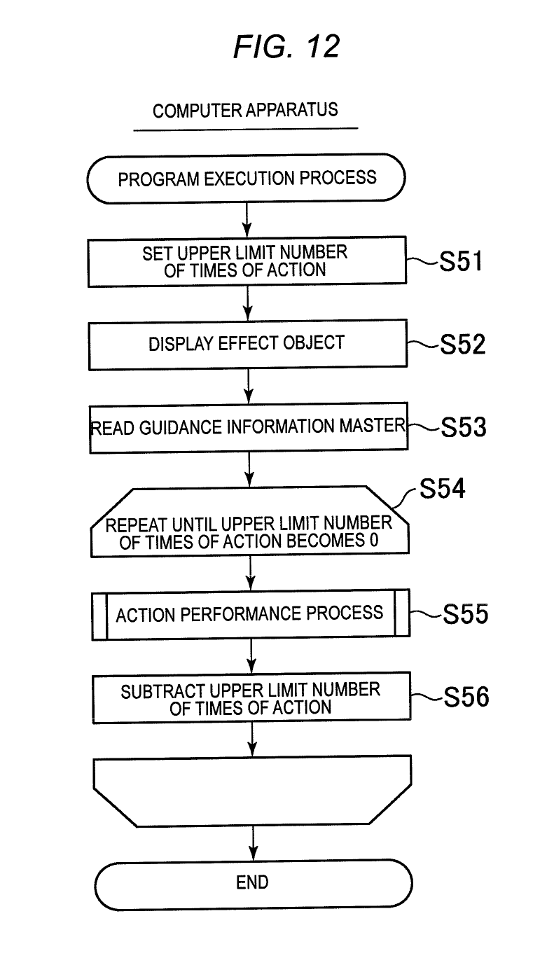

FIG. 12 is a flowchart of a program execution process, corresponding to at least one of the embodiments of the invention. If a virtual battle is started, or if an attack from an enemy character is terminated and it is a player character's turn to perform an action such as an attack, the computer apparatus 1 sets an upper limit value with respect to the number of times of an action performable by a character (step S51). The upper limit value may be fixed, or may be set to be changed as necessary. Then, objects of the same number as the upper limit value set in step S51 are displayed on the display screen 22 (step S52). As described later, effects to be reflected when the action of the character is performed are set in the objects. The effects set in the objects may be the same effects, or may be different effects.

The effect objects 306 shown in FIG. 11 are examples of the number of times of the performable action set in step S51 and the objects displayed in step S52. The number of the displayed effect objects 306 represents the number of times of the performable action. Further, the effect objects 306 have different display modes according to the effects. For example, an effect object 306a represents a normal attack, an effect object 306b represents physical recovery of a supporter, an effect object 306c represents doubling of magic attack power, and an effect object 306d represents double attacks, respectively. Further, for example, an effect capable of doubling offensive power using a knife to cause a fatal deterioration according to attribute information of the enemy character may be provided.

Then, the computer apparatus 1 reads a guidance information master, and develops the result into the RAM 12 (step S53). The guidance information master may be read from the storing section 13 or the external memory 18.

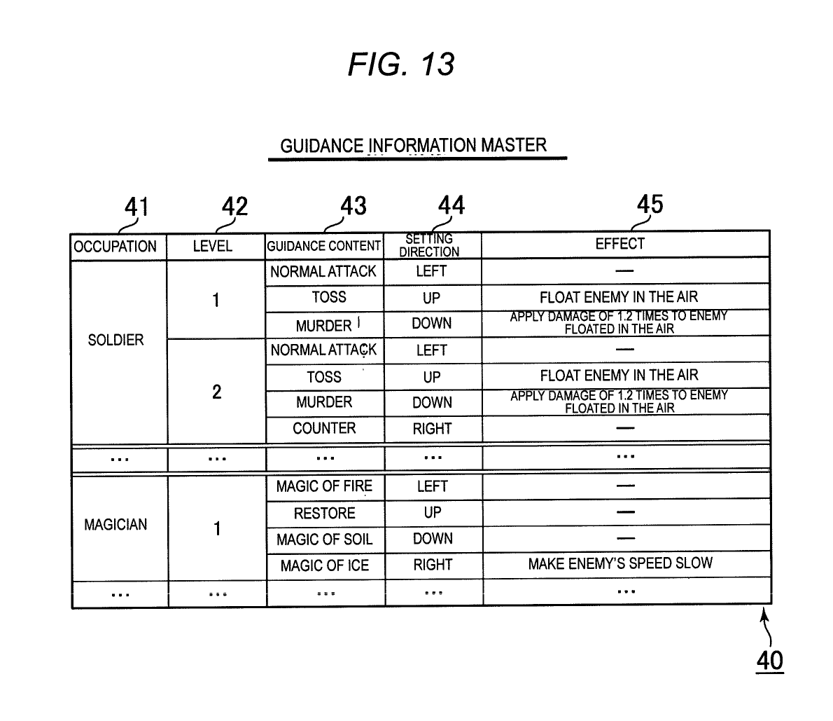

FIG. 13 is a diagram illustrating a guidance information master, corresponding to at least one of the embodiments of the invention. A guidance information master 40 stores a setting direction 44 and an effect 45 in association with an occupation 41, a level 42, and a guidance content 43. The occupation 41 is one of attributes of a character. The level 42 is a value indicating the level of skill of the occupation 41. A character having a high level of skill may be designed to have a large number of performable actions, and a character having a low level of skill may be designed to perform only limited actions.

The guidance content 43 represents a content of an action guided with respect to a character. The setting direction 44 corresponds to a direction of a final location where contact of the user is finished with respect to an initial contact location where the contact is started. The setting direction 44 may be stored corresponding to the guidance content, or may be set to be changed for each character. The effect 45 represents an effect generated when a character performs an action of the guidance content 43.

Subsequently, the computer apparatus 1 determines whether the upper limit number of times of the action is 0 (step S54). Alternatively, the computer apparatus 1 may count the number of times of the action performed by the character, and may compare the number of times of the action performed by the character with the upper limit number of times of the action to perform the determination. If the upper limit number of times of the action is equal to or greater than 1, a player character can perform an action.

Then, the computer apparatus 1 performs an action performance process (step S55). The action performance process will be described later. After the action performance process is completed, the upper limit number of times of the action is subtracted (step S56), and the procedure is terminated. The upper limit number of times of the action may be uniformly subtracted by 1 after the action of the character is completed, or may be subtracted by a predetermined number according to the content of the action performed by the character. If the subtraction process of the upper limit number of times of the action is performed, the effect objects 306 are displayed so that the number thereof is adjusted corresponding to the upper limit number of times of the action after subtraction.

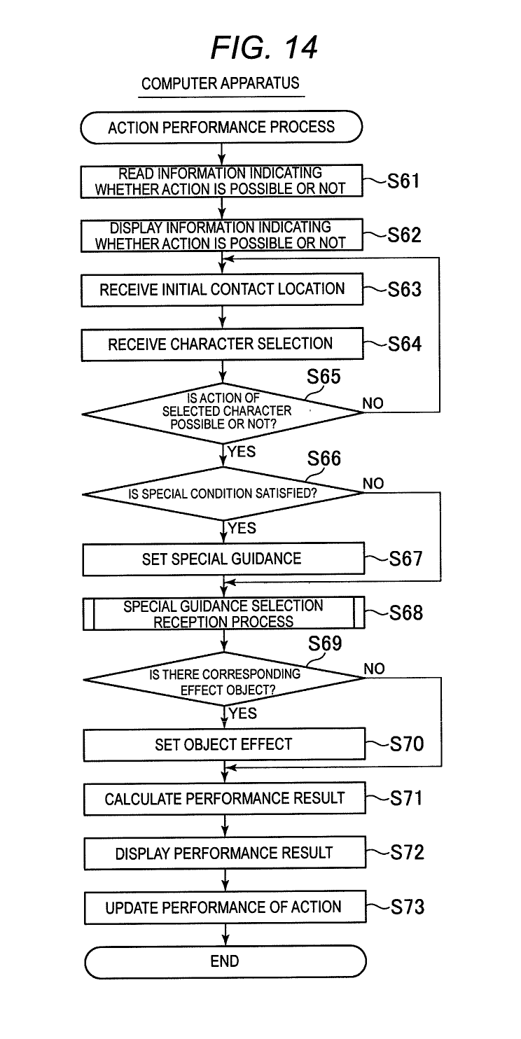

An action performance process in the eighth embodiment of the invention will be described. FIG. 14 is a flowchart of the action performance process, corresponding to at least one of the embodiments of the invention.

The computer apparatus 1 reads information indicating whether an action of each character is possible or not from a character action table, and develops the result into the RAM 12 (step S61). The character action table may be read from the storing section 13 or the external memory 18.

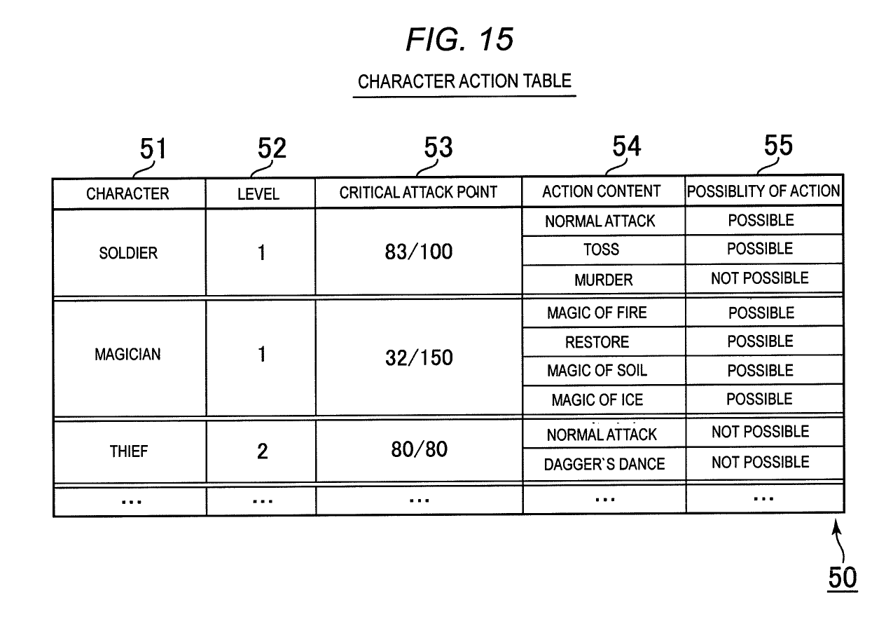

FIG. 15 is a diagram illustrating a character action table, corresponding to at least one of the embodiments of the invention. A character action table 50 stores a level 52, a critical attack point 53, an action content 54, and an action 55 in association with a character 51. The character 51 is information for identifying a character capable of being guided by a user. The level 52 is an attribute of the character 51, and represents a level of skill relating to an action of the character. The critical attack point 53 is used for determination for guiding a special action capable of being guided by a predetermined operation different from a contact operation for deciding a guidance with respect to a character. When the critical attack point 53 is equal to or greater than a predetermined value, or when the critical attack point 53 reaches an upper limit, the guidance of the special action is possible. The action content 54 represents a content of an action that can be performed by the character 51. The action 55 represents performance of an action of the character 51 relating to execution of the action content 54. For example, the design may be performed so that the same character cannot perform the same action in the same turn. That is, it is not possible to guide an action performed once in the same turn.

Subsequently, the information relating to the performance of the action of the character read in step S61 is displayed on the display screen 22 (step S62). It is preferable that the displayed information relating to the action is displayed in the vicinity of each character in order to improve visibility of the information. The information relating to the action may be information indicating that a guidance of the user with respect to a selected character is possible.

The action display images 309 shown in FIG. 11 are information relating to the action of the character displayed in step S62. The action display images 309 are displayed in a direction corresponding to the setting direction 44 of the guidance information master 40, in the vicinity of the character guidance button 304. The action display images 309 are displayed with bright colors when an action is possible, and are displayed with dark colors when the action is not possible. Thus, it is possible to intuitively the discriminate the possibility and impossibility of the action.

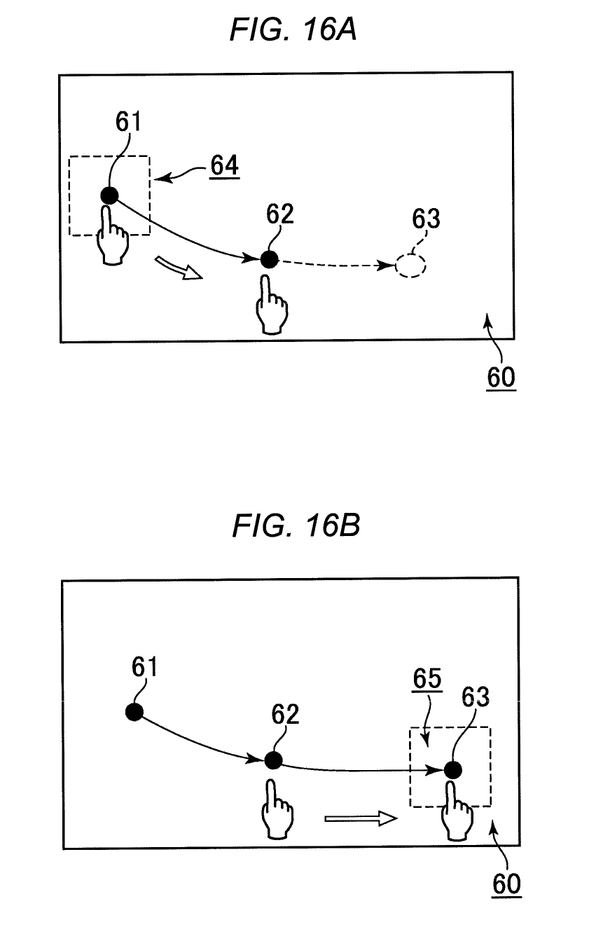

Then, information relating to a user's initial contact location with respect to the display screen 22 is received (step S63). Here, a contact operation of a user with respect to the display screen 22 will be described. FIGS. 16A and 16B are diagrams illustrating a concept relating to user's contact with respect to the display screen, corresponding to at least one of the embodiments of the invention.

In FIGS. 16A and 16B, a case will be described where a user contacts a contact reception area 60 which is a part of the display screen 22 and receives the contact with a user's finger or the like, and moves the finger or the like from an initial contact location 61 through a changed contact location 62 to a final contact location 63 where the user finishes the contact. If the user comes into contact with the initial contact location 61, information relating to coordinates of the initial contact location 61 is received by an input section 23 as input information. The information relating to the coordinates of the initial contact location 61 may be set so that a range 64 which is at a predetermined equal distance from a contact location is set as the contact location.

FIG. 16A is a diagram illustrating a situation where a user moves a finger or the like from the initial contact location 61 to the changed contact position 62 by a slide operation or a flick operation of the user with the finger or the like being in contact with the screen. If the user moves the finger or the like from the initial contact location 61 to the changed contact location 62 with the finger or the like being in contact with the screen, the touch input section 23 continuously detects the contact, and receives information relating to the coordinates whenever the contact is detected.

FIG. 16B is a diagram illustrating a situation where a user moves the finger or the like from the changed contact location 62 to the final contact position 63 by a slide operation or a flick operation of the user with the finger or the like being in contact with the screen. When the contact is finished at the final contact location 63 and is not detected for a predetermined period of time, the computer apparatus 1 specifies the final contact location 63. Information relating to coordinates of the final contact location 63 may be set so that a range 65 which is at a predetermined equal distance from a final contact location 63 is set as the final contact location.

The computer apparatus 1 selects a character corresponding to a received coordinate location based on the information relating to the initial contact location received in step S63 (step S64).

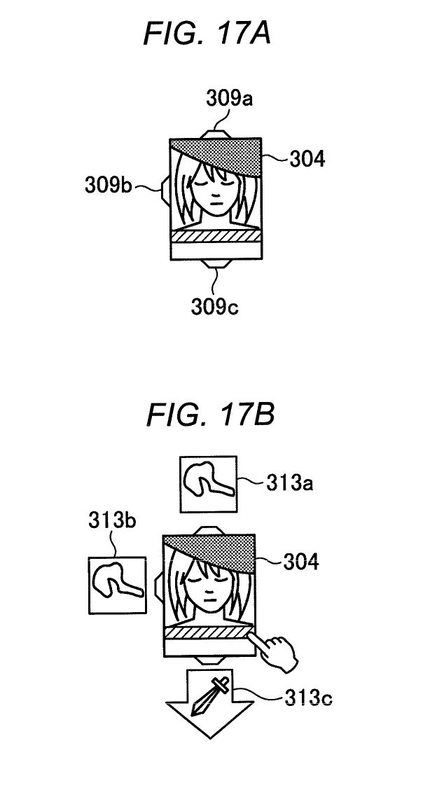

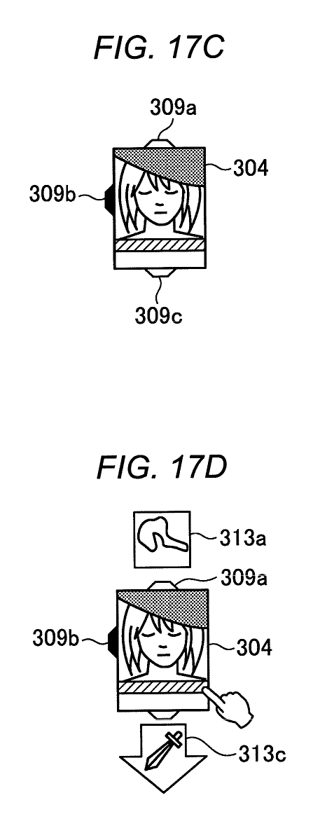

FIGS. 17A to 17D are examples of a performance process in character selection, corresponding to at least one of the embodiments of the invention. FIG. 17A shows a state where a contact operation of a user with respect to a character guidance button 304 is not performed. The action display images 309 are displayed in approximately trapezoidal shapes on an upper side, a left side, and a lower side of the character guidance button 304. The action display images 309 are displayed with bright colors when a character can perform an action corresponding to each direction, and are displayed with dark colors when the character cannot perform the action corresponding to each direction. In FIG. 17A, all of action display images 309a, 309b, and 309c are displayed with bright colors, and thus, an action corresponding to each direction can be performed.

FIG. 17B shows an example of a state where contact with the character guidance button 304 based on a contact operation of a user is detected and a character is selected. The computer apparatus 1 displays an action icon 313 indicating a content of an action performable by the selected character. The action icon represents action content. For example, action icons 313a and 313b represent a magic attack, and an action icon 313c represents a knife attack.

The action icon 313 may represent a special effect generated when an action is performed. The special effect generated when the action is performed refers to an effect 45 of the guidance information master 40. As long as its content has an effect, its shape may be displayed to be changed like the action icon 313c.

FIG. 17C shows an example of a state where a contact operation of a user is not performed with respect to the character guidance button 304 and a part of an action of a character corresponding to the button is not performable. In FIG. 17C, the action display images 309a and 309c are displayed with bright colors, and thus, a character can perform an action corresponding to each of directions, but the action displayer 309b is displayed with a dark color, and thus, the character cannot perform an action corresponding to the direction. In this way, the user can recognize whether an input with respect to each action is possible or not, without contact with the character guidance button 304.

FIG. 17D shows an example of a state where contact with the character guidance button 304 based on a contact operation of a user is detected and a part of an action of a character corresponding to the button cannot be executed. The action icon 313 is not displayed in the direction corresponding to the action displayer 309b.

Then, it is determined whether an action of the selected character is possible or not (step S65). The determination of whether the action is possible or not is performed such that when the entirety of the action 55 relating to the character 51 in the character action table 50 is displayed as not being able to be performed, it is determined that the character cannot perform an action.

When the selected character cannot perform an action (No in step S65), the computer apparatus 1 sends a message indicating that selection is not possible or there is no response to the contact, for example, to prompt the user to select a character again, and may not display guidance information.

When the selected character can perform an action (YES in step S65), it is determined whether the selected character satisfies a special condition (step S66). The special condition means that when the critical attack point 53 in the character action table 50 is a point stored when a predetermined action is executed, the critical attack point 53 is stored up to a maximum value, for example. In FIG. 11, the critical attack point gauge 310 corresponds to the critical attack point 53.

When the special condition is satisfied (YES in step S66), a special guidance for guiding a special action with respect to a character by the user can be selected (step S67). When the special condition is not satisfied (NO in step S66), the guidance content is not changed. The special guidance is a guidance for causing a character to perform a special action, for example, an action for making situations advantageous, such as a strong all-out attack.

Next, a guidance information selection reception process is performed (step S68), and a guidance with respect to a character is selected. The guidance information selection reception process will be described later.

Then, it is determined whether the action of the character based on the guidance selected in step S68 and the effect of the object displayed in step S52 correspond to each other (step S69). When the action of the character and the effect of the object correspond to each other (YES in step S69), the effect of the object is set (step S70). When the action of the character and the effect of the object do not correspond to each other (NO in step S69), the effect of the object is negated.

Then, a performance result of the action of the character based on the guidance selected in step S68 is calculated (step S71). Here, when the effect of the object is generated, the performance result is calculated based on the generated effect. The calculated result is displayed on the display screen 22 (step S72).

Based on the action content of the character that performs the action, the action 55 in the character action table 50 is updated to an impossible state (step S73), and then, the procedure is terminated. The action content 54 which shows action 55 as an impossible state may be changed to be performable again, for example, when a predetermined period of time elapses, or due to use of an item, or the like.

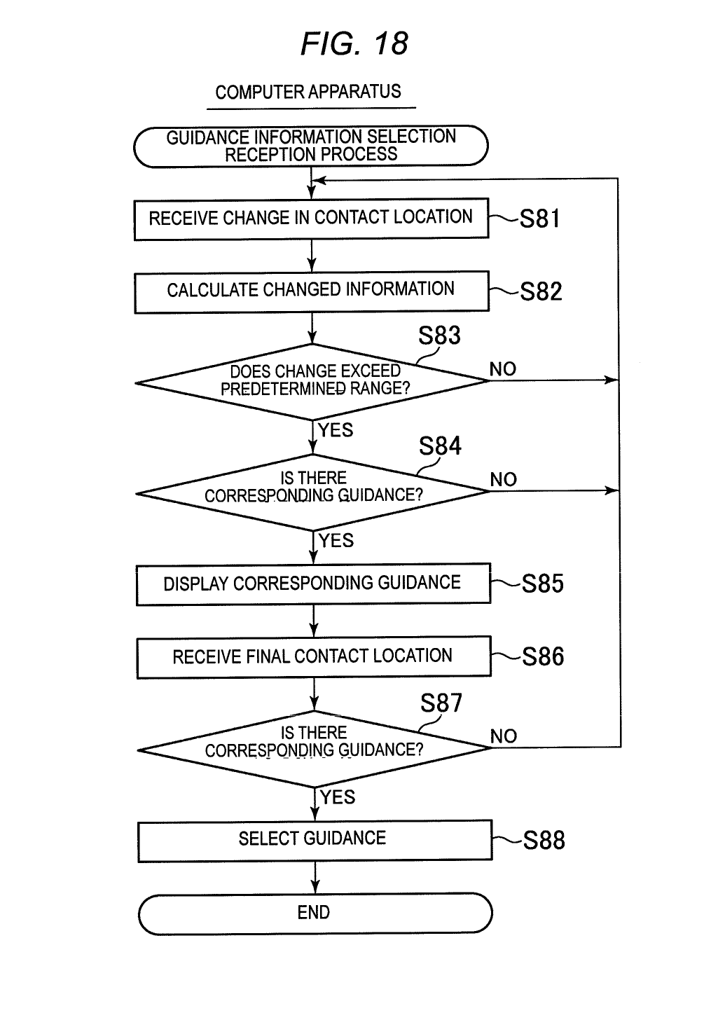

Subsequently, a guidance selection reception process in the eighth embodiment of the invention will be described. FIG. 18 illustrates a flowchart of a guidance information selection reception process, corresponding to at least one of the embodiments of the invention. As described above, the guidance information selection reception process is performed in a state where reception of a user's initial contact location with respect to the display screen 22 is performed.

The computer apparatus 1 receives information relating to a change in a contact location after contact of a user (step S81). Then, the computer apparatus 1 compares an initial contact location with the changed contact location to calculate changed information (step S82). Here, when the contact location is changed to exceed a predetermined range (YES in step S83), the computer apparatus 1 checks the presence or absence of a guidance corresponding to the changed contact location (step S84).

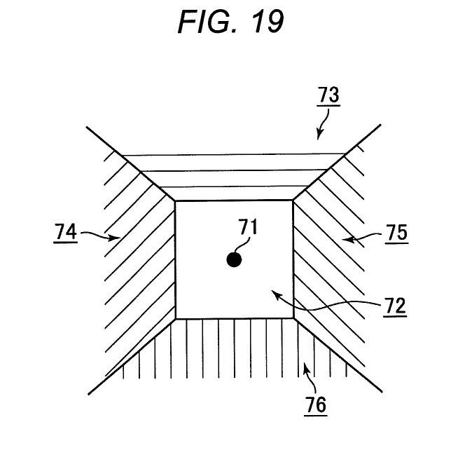

FIG. 19 is a conceptual diagram relating to a change in a process based on a changed contact location, corresponding to at least one of the embodiments of the invention. It is considered that a contact location included in a predetermined range 72 around an initial contact location 71 which is a center of the range 72 matches the initial contact location 71.

When a changed contact location is included in a range 73 on an upper side, a range 74 on a left side, a range 75 on a right side, and a range 76 on a lower side with reference to the predetermined range 72 to exceed the predetermined range 72, information about coordinates relating to each contact location is set as an input, and the information corresponding to the coordinates may be output. Here, the predetermined range 72 does not essentially have an approximately rectangular shape, but may have any shape. Ranges around the predetermined range 72 may not be essentially adjacent to each other, and a space where corresponding information is not present may be present therebetween. Further, information may be set to correspond to coordinates in all the ranges except for the predetermined range 72.

When guidance information corresponding to the changed contact location is present (YES in step S84), the corresponding guidance information is displayed on the display screen 22 (step S85).

Further, when the computer apparatus 1 detects the end of the contact, information relating to a final contact location is received (step S86). Further, the computer apparatus 1 checks again whether guidance information corresponding to the final contact location is present (step S87).

When the guidance information corresponding to the final contact location is present (YES in step S87), selection of the guidance information corresponding to the final contact position is received by the computer apparatus 1 (step S88), and then, the procedure is terminated.

In the eighth embodiment, if the selected character can perform an action, it is possible to give plural guidances to the same character in the same turn. Here, since the action content that is performed once is set to an impossible state, it is not possible to perform the same action content plural times within a predetermined period of time.

As an aspect of the eighth embodiment, it is possible to perform plural times of selection by one contact operation, to thereby efficiently input information.

As another aspect of the eighth embodiment, by displaying information relating to an action, it is possible to enhance visibility of information. Further, by displaying the information relating to the action in association with a direction relating to an operation, it is possible to enhance operability of a user, and to reliably input information.

As still another aspect of the eighth embodiment, by providing an upper limit with respect to the number of times of an action while enabling the same character to perform the action plural times within a predetermined period of time, and by preventing a selected guidance from being selected again until a predetermined condition is satisfied, it is possible to strategically select a character to be guided, to thereby enhance the amusement of a user.

As still another aspect of the eighth embodiment, by introducing an object that generates an effect whenever a character performs an action, it is possible to increasing the variety of action results, to thereby enhance amusement of a user.

As still another aspect of the eighth embodiment, by displaying objects so that the number thereof is adjusted corresponding to an upper limit number of times of an action, and by displaying the objects in the order of the turns of the action, it is possible to obtain different results according to which order the action is performed in by a character, and thus, it is possible to achieve a high level of strategy in a game, to thereby enhance the amusement of a user.

In the eighth embodiment, the “server apparatus” refers to an apparatus that executes a process according to a request from a terminal apparatus, for example. The “touch panel” refers to a panel provided with a touch sensor, for example, in which as a person's finger comes into contact with a screen, an input operation is performed with respect to a computer apparatus. The “terminal apparatus” refers to a computer apparatus such as a portable phone, a smart phone or a portable video game console, for example.

In the eighth embodiment, the “object” refers to a matter that is displayed so that an effect thereof can be visually identified, for example. The “effect of the object” refers to an effect which is achieved, when a character performs a guidance content, as its result, for example, and includes an effect such as improvement in attack power of the character, restoration of physical power, or allowance of plural times of attack. The “character” refers to a player character that is present as an alternative to a game player or a sub character that accompanies the player character, for example, and includes an object that cooperates with the player character.

In the eighth embodiment, the “special condition” refers to a condition for enabling execution of a special action, for example, and includes a case where a point or the like stored by repeating a predetermined action exceeds a predetermined threshold, a case where a predetermined item is provided, or the like. The “special guidance” refers to a guidance for causing a character to perform a special action. The “special action” refers to an action performable only when the special condition is satisfied, which is different from an action such as a normal attack, for example.

In the eighth embodiment, the “initial contact location” refers to a location which is initially detected by the touch panel in a series of motions, relating to contact with the display screen of the terminal apparatus, of contacting the touch-panel display screen by a user's finger or the like and separating the user's finger or the like from the display screen, for example. The “final contact location” refers to a final location which is detected by the touch panel in a series of motions, relating to contact with the display screen, of contacting the touch-panel display screen by the user's finger or the like and separating the user's finger or the like from the display screen. Alternatively, when the contact is not detected for a predetermined period of time, the final contact location may be the latest contact location.

In the eighth embodiment, the “changed contact location” refers to a location after the contact location is changed based on a user's operation, for example, in a series of motions, relating to contact with the display screen of the terminal apparatus, of contacting the touch-panel display screen by the user's finger or the like and separating the user's finger or the like from the display screen, for example, which is a position different from the initial contact position.

In the eighth embodiment, the “guidance information” refers to information relating to a guidance with respect to a character, for example. The “input of the user” refers to an operation for deciding selection of one piece of guidance information from among one or more pieces of guidance information displayed on a screen, for example. The “simplified information” refers to information represented in a form such that the information relating to the guidance information or at least part of the guidance information can be understood.

### Ninth Embodiment

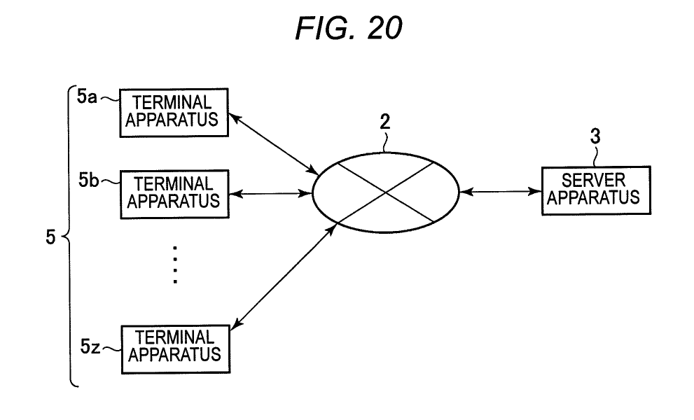

Next, an outline of a ninth embodiment of the invention will be described. FIG. 20 is a block diagram illustrating a configuration of a system, corresponding to at least one of the embodiments of the invention. As shown in the figure, a system includes plural terminal apparatuses 5 (terminal apparatuses 5a, 5b, . . . , 5z) operated by plural users (users A, B, . . . , Z), a server apparatus 3, and a communication line 2. The terminal apparatuses 5 are connected to the server apparatus 3 through the communication line 2. The terminal apparatuses 5 may not be constantly connected to the server apparatus 3, and may be connected thereto as necessary.

A configuration of a terminal apparatus in the ninth embodiment may employ the same configuration as that shown in the block diagram of the computer apparatus of FIG. 10. Further, an execution screen of a program in the ninth embodiment may employ the same configuration as that shown in the example of the execution screen of FIG. 11.

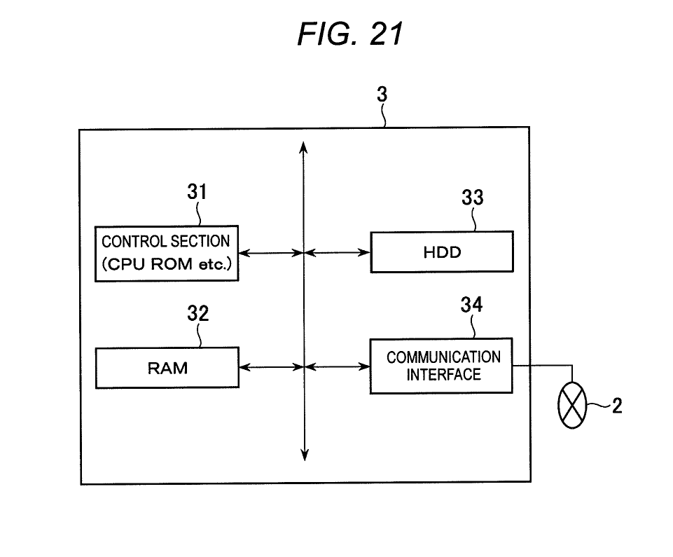

FIG. 21 is a block diagram illustrating a configuration of a server apparatus, corresponding to at least one of the embodiments of the invention. A server apparatus 3 includes a control section 31, a RAM 32, an HDD 33, and a communication interface 34, which are connected to each other through an internal bus.

The control section 31 includes a CPU and a ROM. The control section 31 executes a program stored in the HDD 33, and controls the server apparatus 3. The control section 31 includes an internal timer that counts time. The RAM 32 is a work area of the control section 31. The HDD 33 is a storage area for storing a program or data. The control section 31 reads a program or data from RAM 32, and performs a program execution process based on request information received from the terminal apparatus 5.

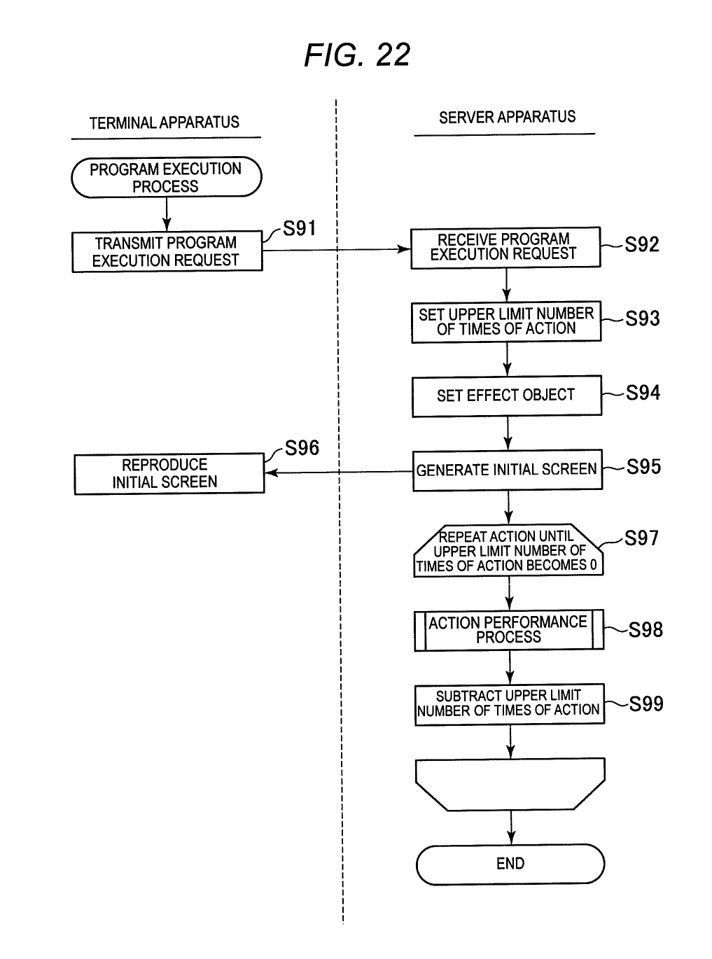

Then, a program execution process in the ninth embodiment of the invention will be described. FIG. 22 is a flowchart of a program execution process, corresponding to at least one of the embodiments of the invention.

If a virtual battle is started, or if an attack from an enemy character is terminated and it is a player character's turn to perform an action such as an attack, the terminal apparatus 5 transmits a program execution request to the server apparatus 3 (step S91). The server apparatus 3 receives the transmitted program execution request (step S92). Then, the server apparatus 3 sets an upper limit value with respect to the number of times of an action performable by a character within a predetermined period of time (step S93). In order to display objects of the same number as the set upper limit value, data relating to the objects is set in data for an initial screen (step S94).

Then, a motion picture relating to the initial display screen is generated, and is transmitted to the terminal apparatus 5 (step S95). The terminal apparatus 5 receives the transmitted motion picture, and reproduces the motion picture on the display screen 22 (step S96).

Subsequently, in the server apparatus 3, it is determined whether the upper limit number of times of the action is 0 (step S97). If the upper limit number of times of the actions is equal to or greater than 1, the player character can perform an action. Then, an action performance process is performed (step S98). The action performance process will be described later. After the action performance process is completed, the upper limit number of times of the action is subtracted (step S99), and the procedure is terminated. The upper limit number of times of the action may be uniformly subtracted by 1 after the action of the character is completed, or may be subtracted by a predetermined number according to the content of the action performed by the character. If the subtraction process of the upper limit number of times of the action is performed, the effect objects are displayed so that the number thereof is adjusted corresponding to the upper limit number of times of the action after subtraction.

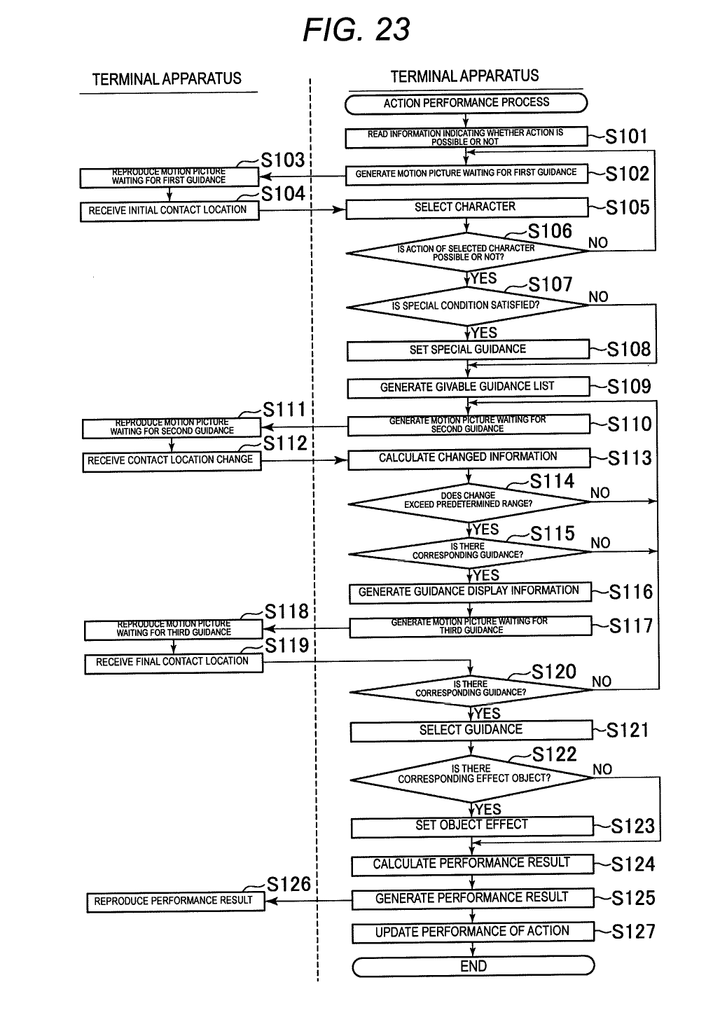

An action performance process in the ninth embodiment of the invention will be described. FIG. 23 is a flowchart of an action performance process, corresponding to at least one of the embodiments of the invention.

The server apparatus 3 reads information indicating whether an action of each character is possible or not from a character action table 50, and develops the result into the RAM 12 (step S101). The character action table 50 may be read from the storing section 13, may be received by the communication interface 16 through the communication network 2, or may be read from the external memory 18.

Subsequently, the server apparatus 3 generates a motion picture for waiting for reception of an operation guidance from the terminal apparatus 5, and transmits the motion picture and the information relating to the action read in step S101 to the terminal apparatus 5 (step S102). The terminal apparatus 5 receives the transmitted information, and reproduces and displays the information on the display screen 22 (step S103). Here, the displayed motion picture is an execution screen 300 of FIG. 11.

The terminal apparatus 5 receives information relating to a user's initial contact location with respect to the display screen 22, and transmits the result to the server apparatus 3 (step S104). The server apparatus 3 selects a character corresponding to the received coordinate position based on the received information relating to the initial contact position (step S105).

Then, it is determined whether the selected character can perform an action or not (step S106). When it is determined that the character cannot perform an action (NO in step S106), the server apparatus 3 sends a message indicating that selection is not possible or there is no response to the contact, for example, to prompt the user to select a character again, and may not display guidance information.

If the selected character can perform an action (YES in step S106), it is determined whether the selected character satisfies a special condition (step S107). When the special condition is satisfied (YES in step S107), a user may select a special guidance for guiding a special action with respect to a character (step S108). When the special condition is not satisfied (No in step S107), a guidance content is not changed.

The server apparatus 3 generates a list of guidances which can be given to the selected character (step S109). Further, the server apparatus 3 generates a motion picture for waiting for reception of an operation guidance from the terminal apparatus 5, and transmits the motion picture and the givable guidance list generated in step S109 to the terminal apparatus 5 (step S110). The terminal apparatus 5 receives the transmitted information, and reproduces and displays the information on the display screen 22 (step S111).

The terminal apparatus 5 receives information relating to a change in the user's contact location with respect to the display screen 22, and transmits the information to the server apparatus 3 (step S112). The server apparatus 3 executes calculation with respect to the changed content using the received information relating to the changed contact location and the information relating to the initial contact location received in step S104 (step S113). Here, when the contact location is changed to exceed a predetermined range (YES in step S114), the server apparatus 3 checks the presence or absence of a guidance corresponding to the changed contact location (step S115).

When the corresponding guidance is present (YES in step S115), the server apparatus 3 generates information relating to corresponding guidance (step S116). Further, the server apparatus 3 generates a motion picture for waiting for reception of the operation guidance from the terminal apparatus 5, and transmits the motion picture and the guidance information generated in step S116 to the terminal apparatus 5 (step S117). The terminal apparatus 5 receives the transmitted information, and reproduces and displays the information on the display screen 22 (step S118).

The terminal apparatus 5 receives information relating to a user's final contact location with respect to the display screen 22, and transmits the information to the server apparatus 3 (step S119). The server apparatus 3 checks the presence or absence of a guidance corresponding to the received final contact location (step S120). When corresponding guidance is present (YES in step S120), the server apparatus 3 selects the corresponding guidance (step S121).

Then, it is determined whether an action of a character based on the guidance selected in step S121 corresponds to an effect of the object set in step S94 (step S122). When the action of the character corresponds to the effect of the object (YES in step S122), the effect of the object is set (step S123). When the action of the character does not correspond to the effect of the object (NO in step S120), the effect of the object is negated.

The server apparatus 3 calculates a performance result of the action of the character (step S124). Then, the server apparatus 3 generates a motion picture relating to the performance result which is a calculation result, and transmits the motion picture to the terminal apparatus 5 (step S125). The terminal apparatus 5 receives the performance result, and reproduces and displays the performance result on the display screen 22 (step S126).

Finally, the server apparatus 3 updates the action 55 in the character action table 50 to an impossible state based on the action content of the character that performs the action (step S127), and then, the procedure is terminated.

In the ninth embodiment, if the selected character can perform an action, it is possible to give plural guidances to the same character in the same turn. Here, since the action content that is performed once is set to an impossible state, it is not possible to perform the same action content plural times within a predetermined period of time.

As an aspect of the ninth embodiment, since the server apparatus executes a process and the terminal apparatus performs only display, input, and transmission/reception of information, even in a terminal apparatus that exhibits low performance, it is possible to execute a high-load program.

As another aspect of the ninth embodiment, by storing data in the server apparatus, even when a processing program is installed in the terminal apparatus, it is possible to perform a control through data change, to thereby perform flexible management.

As still another aspect of the ninth embodiment, it is possible to perform plural times of selection by one contact operation, to thereby efficiently input information.

As still another aspect of the ninth embodiment, by displaying information relating to an action, it is possible to enhance visibility of information. Further, by displaying the information relating to the action in association with a direction relating to an operation, it is possible to enhance operability of a user, and to reliably input information.

As still another aspect of the ninth embodiment, by providing an upper limit with respect to the number of times of an action while enabling the same character to perform an action plural times within a predetermined period of time, and by preventing a selected guidance from being selected again until a predetermined condition is satisfied, it is possible to strategically select a character to be guided, to thereby enhance the amusement of a user.

As still another aspect of the ninth embodiment, by introducing an object that generates an effect whenever a character performs an action, it is possible to increase the variety of action results, to thereby enhance the amusement of a user.

As still another aspect of the ninth embodiment, by displaying objects so that the number thereof is adjusted corresponding to an upper limit number of times of an action, and by displaying the objects in the order of the turns of the action, it is possible to obtain different results according to which order the action is performed in by a character, and thus, it is possible to achieve a high level of strategy in a game, to thereby enhance the amusement of a user.

In the ninth embodiment, the “server apparatus” refers to an apparatus that executes a process according to a request from the terminal apparatus, for example. The “touch panel” refers to a panel provided with a touch sensor, for example, in which as a person's finger comes into contact with a screen, an input operation is performed with respect to a computer apparatus. The “terminal apparatus” refers to a computer apparatus such as a portable phone, a smart phone or a portable video game console, for example.

In the ninth embodiment, the “object” refers to a matter that is displayed so that an effect thereof can be visually identified, for example. The “effect of the object” refers to an effect which is achieved, when a character performs a guidance content, as its result, for example, and includes an effect such as improvement in attack power of the character, restoration of physical power, or allowance of plural times of attack. The “character” refers to a player character that is present as an alternative to a game player or a sub character that accompanies the player character, for example, and includes an object that cooperates with the player character.

In the ninth embodiment, the “special condition” refers to a condition for enabling execution of a special action, for example, and includes a case where a point or the like stored by repeating a predetermined action exceeds a predetermined threshold, a case where a predetermined item is provided, or the like. The “special guidance” refers to a guidance for causing a character to perform a special action. The “special action” refers to an action performable only when the special condition is satisfied, which is different from an action such as a normal attack.

In the ninth embodiment, the “initial contact location” refers to a location which is initially detected by the touch panel in a series of motions, relating to contact with the display screen of the terminal apparatus, of contacting the touch-panel display screen by a user's finger or the like and separating the user's finger or the like from the display screen, for example. The “final contact location” refers to a final location which is detected by the touch panel in a series of motions, relating to contact with the display screen, of contacting the touch-panel display screen by the user's finger or the like and separating the user's finger or the like from the display screen, for example. Alternatively, when the contact is not detected for a predetermined period of time, the final contact location may be the latest contact location.

In the ninth embodiment, the “changed contact location” refers to a location after the contact location is changed based on a user's operation, in a series of motions, relating to contact with the display screen of the terminal apparatus, of contacting the touch-panel display screen by the user's finger or the like and separating the user's finger or the like from the display screen, for example, which is a position different from the initial contact position.

In the ninth embodiment, the “guidance information” refers to information relating to a guidance with respect to a character, for example. The “input of the user” refers to an operation for deciding selection of one piece of guidance information from among one or more pieces of guidance information displayed on a screen, for example. The “simplified information” refers to information represented in a form such that the information relating to the guidance information or at least part of the guidance information can be understood.

Supplementary Note

The above-described embodiments have been described so that the following inventions can be executed by those skilled in the art.

[1] A program executed in a computer apparatus that includes a display device having a touch-panel display screen, the program causing the computer apparatus to function as:

a character selector that selects a character according to a user's initial contact location with respect to the display screen from among a plurality of characters which are displayed on the display screen and can be selected by a user;

a guidance information displayer that displays, when the character is selected by the character selector, guidance information indicating one or more guidances which can be given to the character on the display screen; and

an inputter that receives an input of the user with respect to the guidance information displayed by the guidance information displayer.

[2] The program according to [1],

wherein the guidance information displayer displays, when the character is selected by the character selector, the guidance information in the vicinity of the selected character or in the vicinity of the initial contact location.

[3] The program according to [1] or [2],

wherein the inputter receives information relating to a final contact location where the user ceases the contact to the display screen, and

the guidance information displayer displays guidance information with respect to the selected character, corresponding to the information relating to the final contact location which can be received by the inputter, on the display screen during a contact operation.

[4] The program according to any one of [1] to [3],

wherein the guidance information displayer displays, before the character is selected by the character selector, information obtained by simplifying the guidance information on the display screen.

[5] The program according to [4],

wherein the simplified information is information indicating whether the character is selectable by the user or not among one or more guidances which can be given to the selected character.

[6] The program according to any one of [1] to [5], causing the computer apparatus to further function as:

a guidance selector that selects a guidance with respect to the selected character according to a change in a contact location after initial contact with respect to the display screen; and

a guidance performer that performs a guidance based on information received by the inputter with respect to the selected character.

[7] The program according to [6],

wherein the inputter receives information relating to a final contact location where the user ceases the contact to the display screen, and

the guidance selector selects a guidance according to a direction of the final contact location with respect to the initial contact location.

[8] The program according to [6] or [7],

wherein the guidance selector selects a different guidance with respect to the selected character according to the change in the contact location after the contact with respect to the display screen.

[9] The program according to any one of [6] to [8],

wherein the guidance performer at least temporarily sets an upper limit number of times an action performable by a character corresponding to a guidance, and the character selector is able to select the same character within a range not exceeding the upper limit number,

the program causing the computer apparatus to further function as:

a guidance selection controller that sets the guidance selected by the guidance selector to non-selectable until a predetermined condition is satisfied.

[10] The program according to any one of [6] to [9], causing the computer apparatus to further function as:

an object displayer that displays an object for deciding an effect of an action corresponding to a guidance from the guidance performer; and

an effect decider that decides an effect of an action performed by the guidance performer according to the type of the displayed object.

[11] The program according to [10],

wherein the guidance performer at least temporarily sets an upper limit number of times an action performable by a character corresponding to a guidance,

the object displayer sequentially displays objects of the same number as the upper limit number, and

the effect decider decides the effect of the action performed by the guidance performer according to the type of an object corresponding to the order of an action based on the guidance selected by the guidance selector.

[12] The program according to any one of [6] to [11], causing the computer apparatus to further function as:

a special guidance selector that guides a special action capable of being guided by a predetermined operation different from a contact operation capable of selecting a guidance by the guidance selector,

wherein the guidance performer causes the selected character to perform the special action selected by the special guidance selector.

[13] A computer apparatus that includes a display device having a touch-panel display screen, including:

a character selector that selects a character according to a user's initial contact location with respect to the display screen from among a plurality of characters which are displayed on the display screen and can be selected by a user;

a guidance information displayer that displays, when the character is selected by the character selector, guidance information indicating one or more guidances which can be given to the character on the display screen; and

an inputter that receives an input of the user with respect to the guidance information displayed by the guidance information displayer.

[14] A computer processing method executed in a computer apparatus that includes a display device having a touch-panel display screen, the method executing the steps of:

selecting a character according to a user's initial contact location with respect to the display screen from among a plurality of characters which are displayed on the display screen and can be selected by a user;

displaying, when the character is selected, guidance information indicating one or more guidances which can be given to the character on the display screen; and

receiving an input of the user with respect to the displayed guidance information.

[15] A program executed in a server apparatus capable of being connected to a terminal apparatus that includes a display device having a touch-panel display screen, through communication, the program causing the server apparatus to function as:

a character selector that selects a character according to a user's initial contact location with respect to the display screen from among a plurality of characters which are displayed on the display screen and can be selected by a user;

a guidance information displayer that displays, when the character is selected by the character selector, guidance information indicating one or more guidances which can be given to the character on the display screen; and

an inputter that receives an input of the user with respect to the guidance information displayed by the guidance information displayer.

[16] A server apparatus in which the program according to [15] is installed.

[17] A system that includes a terminal apparatus that includes a display device having a touch-panel display screen and a server apparatus capable of being connected to the terminal apparatus through communication, the system including:

a character selector that selects a character according to a user's initial contact location with respect to the display screen from among a plurality of characters which are displayed on the display screen and can be selected by a user;

a guidance information displayer that displays, when the character is selected by the character selector, guidance information indicating one or more guidances which can be given to the character on the display screen; and

an inputter that receives an input of the user with respect to the guidance information displayed by the guidance information displayer.

[18] A program executed in a terminal apparatus that includes a display device having a touch-panel display screen and is capable of communicating with a server apparatus,

wherein the server apparatus receives information from the terminal apparatus, selects a character according to a user's initial contact location with respect to the display screen from among a plurality of characters which are displayed on the display screen and can be selected by a user, and displays, when the character is selected, guidance information indicating one or more guidances which can be given to the character on the display screen,

the program causing the terminal apparatus to function as:

an inputter that receives an input of the user with respect to the guidance information displayed by a guidance information displayer; and

an information transmitter that transmits the received input information to the server apparatus.

[19] A terminal apparatus in which the program according to [18] is installed.

[20] A computer processing method executed in a server apparatus capable of being connected to a terminal apparatus that includes a display device having a touch-panel display screen, through communication, the method executing the steps of:

selecting a character according to a user's initial contact location with respect to the display screen from among a plurality of characters which are displayed on the display screen and can be selected by a user;

displaying, when the character is selected, guidance information indicating one or more guidances which can be given to the character on the display screen; and

receiving an input of the user with respect to the displayed guidance information.

[21] A computer processing method executed in a system that includes a terminal apparatus that includes a display device having a touch-panel display screen and a server apparatus capable of being connected to the terminal apparatus through communication, the method executing the steps of:

selecting a character according to a user's initial contact location with respect to the display screen from among a plurality of characters which are displayed on the display screen and can be selected by a user;

displaying, when the character is selected, guidance information indicating one or more guidances which can be given to the character on the display screen; and

receiving an input of the user with respect to the displayed guidance information.

1. A non-transitory computer-readable recording medium having recorded thereon an program which is executed in a computer apparatus that includes a display device having a touch-panel display screen, the program causing the computer apparatus to function as:
a character selector that selects a character according to a user's initial contact location with respect to the display screen from among a plurality of characters which are displayed on the display screen and can be selected by a user;
a guidance information displayer that displays, when the character is selected by the character selector, guidance information indicating one or more guidances which can be given to the character on the display screen; and
an inputter that receives an input of the user with respect to the guidance information displayed by the guidance information displayer.

2. The non-transitory computer-readable recording medium according to claim 1,
wherein the guidance information displayer displays, when the character is selected by the character selector, the guidance information in the vicinity of the selected character or in the vicinity of the initial contact location.

3. The non-transitory computer-readable recording medium according to claim 1,
wherein the inputter receives information relating to a final contact location where the user ceases the contact to the display screen, and
the guidance information displayer displays guidance information with respect to the selected character, corresponding to the information relating to the final contact location which can be received by the inputter, on the display screen during a contact operation.

4. The non-transitory computer-readable recording medium according to claim 1,
wherein the guidance information displayer displays, before the character is selected by the character selector, information obtained by simplifying the guidance information on the display screen.

5. The non-transitory computer-readable recording medium according to claim 4,
wherein the simplified information is information indicating whether the character is selectable by the user or not among one or more guidances which can be given to the selected character.

6. The non-transitory computer-readable recording medium according to claim 1, causing the computer apparatus to further function as:
a guidance selector that selects a guidance with respect to the selected character according to a change in a contact location after initial contact with respect to the display screen; and
a guidance performer that performs a guidance based on information received by the inputter with respect to the selected character.

7. A computer apparatus that includes a display device having a touch-panel display screen, including:
a character selector that selects a character according to a user's initial contact location with respect to the display screen from among a plurality of characters which are displayed on the display screen and can be selected by a user;
a guidance information displayer that displays, when the character is selected by the character selector, guidance information indicating one or more guidances which can be given to the character on the display screen; and
an inputter that receives an input of the user with respect to the guidance information displayed by the guidance information displayer.

8. A computer processing method executed in a computer apparatus that includes a display device having a touch-panel display screen, the method executing the steps of:
selecting a character according to a user's initial contact location with respect to the display screen from among a plurality of characters which are displayed on the display screen and can be selected by a user;
displaying, when the character is selected, guidance information indicating one or more guidances which can be given to the character on the display screen; and
receiving an input of the user with respect to the displayed guidance information.
